(19) United States
(12) Patent Application Publication
(10) Pub. No.: US 2025/0263328 A1
(43) Pub. Date: Aug. 21, 2025

(54) LITHIUM-FREE HIGH MODULUS FIBERGLASS COMPOSITION

(71) Applicant: Owens Corning Intellectual Capital, LLC, Toledo, OH (US)

(72) Inventor: Michelle L. Korwin-Edson, Granville, OH (US)

(21) Appl. No.: 19/049,054

(22) Filed: Feb. 10, 2025

Related U.S. Application Data
(60) Provisional application No. 63/553,678, filed on Feb. 15, 2024.

(51) Int. Cl. C03C 13/00; C03B 37/022; C03C 3/095; C08J 5/04

(52) U.S. Cl. CPC C03C 13/00; C03C 3/078; C03C 3/095; C03C 13/046; C08J 5/043; C03B 37/022; C03C 2213/00

(57) ABSTRACT

Glass compositions are disclosed that include SiO₂ in an amount of from 50 wt. % to 60 wt. %; Al₂O₃ in an amount of less than 20 wt. %; CaO in an amount of less than 5 wt. %; MgO in an amount of greater than or equal to 15 wt. %; Y₂O₃ and, optionally, La₂O₃ present in a sum concentration of from 2 wt. % to 6 wt. %; and less than 0.5 wt. % of Li₂O. The glass composition has a Young's modulus of greater than or equal to 93 GPa.

### CROSS-REFERENCE TO RELATED APPLICATIONS

This application claims priority to and all benefit of U.S. Provisional Patent Application No. 63/553,678, filed on Feb. 15, 2024, the entire disclosure of which is fully incorporated herein by reference.

### BACKGROUND OF THE INVENTION

Glass fibers are manufactured from various raw materials combined in specific proportions to yield a desired composition, commonly termed a “glass batch.” This glass batch may be melted in a melting apparatus and the molten glass is drawn into filaments through a bushing or orifice plate (the resultant filaments are also referred to as continuous glass fibers). A sizing composition containing lubricants, coupling agents and film-forming binder resins may then be applied to the filaments. After the sizing is applied, the fibers may be gathered into one or more strands and wound into a package or, alternatively, the fibers may be chopped while wet and collected. The collected chopped strands may then be dried and cured to form dry chopped fibers, or they can be packaged in their wet condition as wet chopped fibers.

The composition of the glass batch, along with the fiberglass manufactured therefrom, is often expressed in terms of the oxides contained therein. Numerous types of glasses may be produced by varying the presence or absence of particular oxides or varying particular oxide relationships and ratios within a glass batch. Examples of such glasses that may be produced include R-glass, E-glass, S-glass, A-glass, C-glass, ECR-glass, and more recently, high performance glass (i.e., high modulus and/or high strength glass). The glass composition controls the forming and product properties of the glass. Other characteristics of glass compositions include the raw material cost and availability and environmental impact.

For instance, high performance glass fibers possess higher strength and stiffness, compared to traditional E-glass fibers. In particular, for some products, stiffness is crucial for modeling and performance. For example, composites, such as wind blades, prepared from glass fibers with good stiffness properties would allow for longer wind blades on electrical generating wind stations while keeping flexure of the blade within acceptable limits. Conventionally, lithium is added to glass fiber compositions to obtain both desirable mechanical and forming properties. For example, lithium is very effective in reducing the viscosity of the glass formulation.

Although lithium-containing glass compositions may possess desirable properties with respect to mechanical and forming properties, there are various considerations that make it desirable to reduce and/or eliminate lithium in a glass composition, such as cost, ability to source lithium-containing raw materials, etc.

Accordingly, glass compositions that reduce or eliminate lithium and limit expensive raw materials such as rare earth oxides are desired that are nonetheless capable of producing high mechanical performance (i.e., high Young's modulus) glass fibers, while maintaining desirable forming properties (e.g., fiberizing temperature).

### SUMMARY OF THE INVENTION

Various exemplary aspects of the present inventive concepts are directed to a glass composition comprising: SiO₂ in an amount of from 50 wt. % to 60 wt. %; Al₂O₃ in an amount of less than 20 wt. %; CaO in an amount of less than 5 wt. %; MgO in an amount of greater than or equal to 15 wt. %; Y₂O₃ and La₂O₃ present in a sum concentration of from 2 wt. % to 6 wt. %; and less than 0.5 wt. % of Li₂O. The glass composition has a Young's modulus of greater than or equal to 93 GPa.

In any of the exemplary aspects, the glass composition has a Young's modulus or greater than or equal to 95 GPa. In any of the aspects disclosed herein, the glass composition may comprise amounts of SiO₂, MgO, and CaO that satisfy the relationship SiO₂/(MgO+CaO)≤3.3, MgO/CaO≥11.0, and/or 11.0≤MgO/CaO≤14.0. In any of the aspects disclosed herein, the glass composition may comprise amounts of Al₂O₃ and MgO that satisfy the relationship Al₂O₃/MgO≤1.5 and/or 0.75≤Al₂O₃/MgO≤1.5.

Various exemplary aspects of the present inventive concepts are directed to a lithium-free glass composition comprising: SiO₂ in an amount of from 50 wt. % to 60 wt. %; Al₂O₃ in an amount of from 15 wt. % to 20 wt. %; CaO in an amount of from 1 wt. % to 5 wt. %; MgO in an amount of greater than or equal to 15 wt. %; and Y₂O₃ and La₂O₃ present in a sum concentration of from 2 wt. % to 6 wt. %, wherein the glass composition has a Young's modulus of greater than or equal to 95 GPa. The glass composition satisfies at least one of the following: the glass composition comprises amounts of SiO₂, MgO, and CaO that satisfy the relationship SiO₂/(MgO+CaO)<3.0; the glass composition comprises amounts of MgO and CaO that satisfy the relationship MgO/CaO≥12.5; and the glass composition comprises amounts of Al₂O₃ and MgO that satisfy the relationship Al₂O₃/MgO≤1.0.

In any of the exemplary aspects set forth above, the glass composition may further comprise ZrO₂ in an amount of from 0.1 wt. % to 2 wt. %, TiO₂ in an amount of from 0.1 wt. % to 2 wt. %, Fe₂O₃ in an amount of from 0 wt. % to 3 wt. %, and/or ZnO in an amount of from 0 wt. % to 3 wt. %. In any of the exemplary aspects set forth above, the glass composition further comprise CeO₂.

In any of the exemplary aspects disclosed herein, the glass composition may include Y₂O₃ in an amount that is greater than the amount of La₂O₃ present in the glass composition and/or a total content of R₂O (R₂O═Li₂O+Na₂O+K₂O) of less than 2 wt. %. In any exemplary aspect, the glass composition has a fiberizing temperature that is less than 1315° C.

The foregoing and other objects, features, and advantages of the invention will appear more fully hereinafter from a consideration of the detailed description that follows.

### DETAILED DESCRIPTION

Unless otherwise defined, all technical and scientific terms used herein have the same meaning as commonly understood by one of ordinary skill in the art to which these exemplary embodiments belong. The terminology used in the description herein is for describing exemplary embodiments only and is not intended to be limiting of the exemplary embodiments. Accordingly, the general inventive concepts are not intended to be limited to the specific embodiments illustrated herein. Although other methods and materials similar or equivalent to those described herein can be used in the practice or testing of the present invention, the preferred methods and materials are described herein.

As used in the specification and the appended claims, the singular forms “a,” “an,” and “the” are intended to include the plural forms as well, unless the context clearly indicates otherwise.

Unless otherwise indicated, all numbers expressing quantities of ingredients, chemical and molecular properties, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present exemplary embodiments. At the very least each numerical parameter should be construed in light of the number of significant digits and ordinary rounding approaches.

Notwithstanding that the numerical ranges and parameters setting forth the broad scope of the exemplary embodiments are approximations, the numerical values set forth in the specific examples are reported as precisely as possible. Any numerical value, however, inherently contains certain errors necessarily resulting from the standard deviation found in their respective testing measurements. Every numerical range given throughout this specification and claims will include every narrower numerical range that falls within such broader numerical range, as if such narrower numerical ranges were all expressly written herein. Moreover, any numerical value reported in the Examples may be used to define either an upper or lower end-point of a broader compositional range disclosed herein.

Percentages by weight (“wt. %”) are reported herein on the basis of total oxides in the glass composition, unless otherwise specified.

Although the glass composition of the subject inventive concepts may be described and/or claimed in various ways, it should be appreciated the different compositions are alternative solutions to the particular problem addressed herein and are all part of the general inventive concepts disclosed.

The present disclosure relates to a high-modulus glass composition with surprisingly good forming properties, while being essentially lithium free. By “essentially lithium free,” it is meant that the glass composition includes no greater than 2.0% by weight of lithium, including no greater than 1.5% by weight, 1.2% by weight, 1.0% by weight, 0.8% by weight, 0.5% by weight, 0.1% by weight, 0.05% by weight, and 0.01% by weight. In some exemplary embodiments, the glass composition includes between 0 and 1.0% by weight lithium, including between 0 and 0.5% by weight, and between 0 and 0.05% by weight. In any of the exemplary embodiments, the glass composition may be entirely free of lithium.

Removing lithium (in the form of Li₂O) from a glass composition necessarily requires increasing other oxides, particularly when attempting to maintain sufficient mechanical properties, such as a high Young's modulus (i.e., at least 90 GPa). However, it was surprisingly discovered that the concentration of particular oxides needed to be increased to levels higher than the level of Li₂O that was removed from the composition. In particular, the glass composition according to the present inventive concepts includes a high concentration of magnesium oxide (MgO), while surprisingly demonstrating satisfactory forming properties, including liquidus temperature and the temperature differential (“ΔT”) between the liquidus temperature and the fiberizing temperature, although MgO has traditionally been known to cause higher liquidus temperatures. Moreover, advancing technologies in fiberizing technology enable the use of glass compositions with lower viscosities, including those with small (or negative) ΔT.

Particularly, the present glass composition includes a particular blend of oxides in precise relationships in order to produce a lithium-free glass fiber having a high Young's modulus, while maintaining desirable forming properties. The composition includes, as its basic components, particular amounts of SiO₂, Al₂O₃, CaO, and MgO, with the total amount of SiO₂+Al₂O₃+MgO+CaO being less than or equal to 99.5% by weight. In exemplary embodiments, the concentrations of SiO₂, Al₂O₃, CaO, and MgO are such that the glass composition meets one or more of the following relationships: SiO₂/(MgO+CaO) ratio less than or equal to 3.3; MgO/CaO ratio greater than or equal to 11.0; and Al₂O₃/MgO ratio less than or equal to 1.5. In exemplary embodiments, the concentrations of SiO₂, Al₂O₃, CaO, and MgO are such that the glass composition meets one or more of the following relationships: SiO₂/(MgO+CaO) ratio less than 3.0; MgO/CaO ratio greater than or equal to 12.5; and Al₂O₃/MgO ratio less than or equal to 1.0. In some exemplary embodiments, the concentrations of SiO₂, Al₂O₃, CaO, and MgO are such that the glass composition meets at least two of the foregoing relationships.

In any of the exemplary embodiments, the glass composition may include SiO₂ in an amount of 50 wt. % to 60 wt. %, Al₂O₃ in an amount of less than 20 wt. %, CaO in an amount of less than 5 wt. %, MgO in an amount of greater than or equal to 15 wt. %, one or more rare earth oxides present in a sum concentration of from 2 wt. % to 6 wt. %, and less than 0.5 wt. % of Li₂O. In certain exemplary embodiments, the glass composition is a lithium-free glass composition that may include SiO₂ in an amount of 50 wt. % to 60 wt. %, Al₂O₃ in an amount of 15 wt. % to 20 wt. %, CaO in an amount of 1 wt. % to 5 wt. %, MgO in an amount of greater than or equal to 15 wt. %, one or more rare earth oxides present in a sum concentration of from 2 wt. % to 6 wt. %.

The glass composition includes at least 50 wt. %, but no greater than 60 wt. % SiO₂. The glass composition may include at least 52 wt. % SiO₂, including at least 53.5 wt. %, at least 54 wt. %, at least 55 wt. %, and at least 55.5 wt. %. In some instances, the glass composition includes no greater than wt. % SiO₂, including no greater than 59 wt. %, no greater than 58.5 wt. %, no greater than 58 wt. %, no greater than 57.8 wt. %, no greater than 57.5 wt. %, no greater than 57.2 wt. %, and no greater than 57 wt. %.

Thus, certain embodiments of the glass composition include SiO₂ in an amount between 50 wt. % and less than 60 wt. %, including, for example, between 53 wt. % and 59 wt. %, 53.5 wt. % and 58 wt. %, 54 wt. % and 57.5 wt. %, and 54.5 wt. % and 57 wt. %, including all subranges and endpoints therein.

To achieve both the desired mechanical and fiberizing properties, the glass composition has an Al₂O₃ concentration of at least 15 wt. % and no greater than 20 wt. %. Al₂O₃ helps to improve glass modulus, but also tends to increase the glass liquidus, which could impact the glass ΔT. Thus, the subject glass composition includes a balanced amount of Al₂O₃ in comparison to other oxides to achieve the highest benefit to modulus with as little impact to the liquidus temperature as possible. In some embodiments, the glass composition includes Al₂O₃ in an amount between 15.5 wt. % and 20 wt. %, including between 16 wt. % and 20 wt. %, between 16.5 wt. % and 20 wt. %, between 17 wt. % and 20 wt. %, between 16 wt. % and 19.5 wt. %, between 16.5 wt. % and 19.5 wt. %, between 17 wt. % and 19.5 wt. %, between 16 wt. % and 19 wt. %, between 16.5 wt. % and 19 wt. %, and between 17 wt. % and 19 wt. %, including all endpoints and subranges therebetween.

As mentioned above, it has been surprisingly discovered that glass composition can include a relatively high concentration of MgO, while maintaining sufficient melt and forming properties. Thus, the glass composition includes an amount of greater than or equal to 15 wt. % MgO, including at least 15.5 wt. %, at least 16 wt. %, at least 16.5 wt. %, at least 17 wt. %, and at least 17.5 wt. % MgO. Additionally, the glass composition includes less than or equal to 20 wt. % MgO, including no greater than 19.5 wt. %, and no greater than 19 wt. % MgO. In some exemplary embodiments, the glass composition includes 15 wt. % to 20 wt. % MgO, including 15.5 wt. % to 20 wt. % MgO, 16 wt. % to 20 wt. % MgO, 16.5 wt. % to 20 wt. % MgO, 17 wt. % to 20 wt. % MgO, 17.5 wt. % to 20 wt. % MgO, 15 wt. % to 19.5 wt. % MgO, 15.5 wt. % to 19.5 wt. % MgO, 16 wt. % to 19.5 wt. % MgO, 16.5 wt. % to 19.5 wt. % MgO, 17 wt. % to 19.5 wt. % MgO, 17.5 wt. % to 19.5 wt. % MgO, 15 wt. % to 19 wt. % MgO, 15.5 wt. % to 19 wt. % MgO, 16 wt. % to 19 wt. % MgO, 16.5 wt. % to 19 wt. % MgO, 17 wt. % to 19 wt. % MgO, and 17.5 wt. % to 19 wt. % MgO, including all endpoints and subranges therebetween.

Another important aspect of the subject glass composition that makes it possible to achieve the desired mechanical and fiberizing properties, is having an Al₂O₃/MgO ratio of less than or equal to 1.5. In certain exemplary aspects, the Al₂O₃/MgO ratio is less than or equal to 1.5, or less than or equal to 1.25, or greater than or equal to 1.0. The Al₂O₃/MgO ratio should also be greater than or equal to 0.75, such as greater than 0.8, and greater than 0.9, makes it possible to obtain glass fibers with desirable fiberizing properties and Young's modulus of at least 93 GPa.

The glass composition advantageously includes less than 5 wt. % CaO. As mentioned above, the glass composition includes a reduced concentration of CaO, compared to conventional compositions, which reduces the carbon emissions during manufacturing, while also improving the elastic modulus of formed fibers. CaO tends to negatively impact Young's modulus, and therefore including greater than 5 wt. % CaO may produce a glass with a low Young's modulus. Accordingly, the glass composition includes less than 5 wt. % CaO, such as, for example, less than or equal to 4.5 wt. %, less than or equal to 4 wt. %, less than or equal to 3.5 wt. %, less than or equal to 3 wt. %, less than or equal to 2.5 wt. %, less than or equal to 2 wt. %, or less than or equal to 1.5 wt. % CaO. In some exemplary embodiments, the glass composition includes at least 0.5 wt. % CaO, including at least 0.75 wt. %, at least 1.0 wt. %, and at least 1.25 wt. % CaO.

In any of the exemplary embodiments, the total concentration of CaO and MgO in the glass composition should be no greater than 26% wt. %, such as, for example, no greater than 25 wt. %, no greater than 22 wt. %, no greater than 21.5 wt. %, no greater than 21 wt. %, no greater than 20.5 wt. %, and no greater than 20 wt. %. The glass composition includes a total concentration of MgO and CaO that is at least 17 wt. % and no greater than 26 wt. %, including between 18 wt. % and 24 wt. % and between 19 wt. % and 22 wt. %. In any of the exemplary embodiments, the total concentration of MgO and CaO may be at least 17 wt. %. In any of the exemplary embodiments, the glass composition may include both CaO and MgO.

By selecting a synergistic amount of CaO and MgO, various embodiments may include a limited total amount of Y₂O₃ and La₂O₃ and less than 0.5 wt. % of Li₂O without adversely impacting the elastic modulus of the glass composition. The result may be glass compositions that can be manufactured for a lower cost without sacrificing performance properties. Accordingly, in any of the exemplary embodiments, the glass composition may include a ratio of the amount of MgO to the amount of CaO (MgO/CaO) of from 10 to 15, including from 10.5 to 14.5, from 11 to 14, from 11.5 to 13.5, and from 12 to 13.5. In exemplary embodiments, the glass composition may include a ratio of the amount of MgO to the amount of CaO (MgO/CaO) of greater than or equal to 12.5.

The glass composition further includes a combined amount of SiO₂, Al₂O₃, MgO, and CaO that is less than or equal to 99.5 wt. % and at least 92 wt. %, or at least 93 wt. %. In some exemplary embodiments, the combined amount of SiO₂, Al₂O₃, MgO, and CaO is between 92 wt. % and 99.5 wt. %, including between 93 wt. % and 98 wt. % and between 93 wt. % and 95 wt. %.

In any of the exemplary embodiments, the total concentration of MgO and CaO is such that the ratio of SiO₂ to the combined concentrations of MgO and CaO (e.g., SiO₂/(CaO+MgO)) is less than or equal to 3.3, including less than or equal to 3.2, less than or equal to 3.1, and less than or equal to 3. In embodiments, the total concentration of MgO and CaO is such that the ratio of SiO₂ to the combined concentrations of MgO and CaO (e.g., SiO₂/(CaO+MgO)) may be particularly tailored to between 2.5 and 3.3, including from 2.6 to 3.3, from 2.7 to 3.3, from 2.5 to 3, from 2.6 to 3, and from 2.7 to 3, including all endpoints and subranges therebetween. In some exemplary embodiments, the ratio of SiO₂ to the combined concentrations of MgO and CaO (e.g., SiO₂/(CaO+MgO)) is less than 3. SiO₂ is the primary glass former (O—Si—O linkages, with 4 oxygens to each silicon and 2 silicons to each oxygen) and the alkaline earth oxides CaO and MgO contribute Ca²⁺ and Mg²⁺ cations to the structure, each of which create two non-bridging oxygens (NBOs) in the glass former linkages. A ratio of SiO₂/(CaO+MgO) above 3 would indicate that there are too many bridging oxygens in the structure, which may lead to high viscosity and difficulty in forming due to the high temperatures required to reach the forming viscosity. A ratio of SiO₂/(CaO+MgO) below 2.5 may result in too many NBOs and a very broken or flexible structure, which leads to a low viscosity, along with a low strength and modulus. A balance in the SiO₂/(CaO+MgO) ratio value has been discovered to achieve the desired properties for both forming and application in the market.

It has been found that this particular combination and concentration of the rare earth oxides. Y₂O₃ and La₂O₃, helps to reduce the fiberizing temperature, while enabling the production glass fibers with sufficient elastic modulus and tensile strengths. Thus, in any of the exemplary embodiments, the glass composition includes Y₂O₃ or both Y₂O₃ and La₂O₃. Particularly, the subject glass composition includes a total concentration of Y₂O₃ and La₂O₃ of at least 2 wt. %, and if La₂O₃ is present, the composition has a ratio of Y₂O₃/La₂O₃ between 1.5 and 4. In any aspect including La₂O₃, the glass composition includes an amount of Y₂O₃ that is greater than the amount of La₂O₃. For example, in any of the exemplary embodiments, the glass composition may include a Y₂O₃/La₂O₃ ratio of from 1.6 to 3.8, including from 1.7 to 3.6, from 1.8 to 3.4, from 1.9 to 3.1, from 1.6 to 2.8, including from 1.7 to 2.6, from 1.8 to 2.4, and from 1.9 and 2.1, including all endpoints and subranges therebetween.

Additionally, as mentioned above, the total concentration of Y₂O₃ and La₂O₃ is at least 2 wt. %, including, for example, at least 2.5 wt. %, at least 2.7 wt. %, at least 3 wt. %, at least 3.3 wt. %, at least 3.5 wt. %, at least 3.8 wt. %, at least 4 wt. %, and at least 4.2 wt. %. Likewise, the total concentration of Y₂O₃ and La₂O₃ may be no greater than 6 wt. %, including, for example, no greater than 5.6 wt. %, no greater than 5.4 wt. %, no greater than 5.2 wt. %, no greater than 5 wt. %, and no greater than 5.8 wt. %. In any of the exemplary embodiments, the glass composition may include from 2 wt. % to 6 wt. % of Y₂O₃ and La₂O₃, collectively, including from 2.5 wt. % to 5.8 wt. %, from 2.8 wt. % to 5.5 wt. %, from 3.0 wt. % to 5.2 wt. %, from 3.3 wt. % to 5 wt. %, from 3.5 wt. % to 4.8 wt. %, and from 4 wt. % to 4.5 wt. %, including all endpoint and ranges therebetween.

With regard to these oxides individually, the glass composition may include at least 1 wt. % Y₂O₃, including, for example, at least 1.2 wt. %, at least 1.4 wt. %, at least 1.6 wt. %, at least 1.8 wt. %, at least 2 wt. %, at least 2.2 wt. %, at least 2.4 wt. %, and at least 2.6 wt. % Y₂O₃. Likewise, the glass composition may include no greater than 5.5 wt. % Y₂O₃, including, for example, no greater than 5 wt. %, no greater than 4.8 wt. %, no greater than 4.5 wt. %, no greater than 4.3 wt. %, no greater than 4 wt. %, no greater than 3.8 wt. %, no greater than 3.5 wt. %, no greater than 3.3 wt. %, and no greater than 3 wt. % Y₂O₃. In any of the exemplary embodiments, the glass composition may include from greater than 1 wt. % to less than 5.5 wt. % Y₂O₃, including from 1.4 wt. % to 4.5 wt. %, from 1.6 wt. % to 3 wt. %, and from 1.8 wt. % to 2.7 wt. %, including all endpoint and ranges therebetween.

Additionally, the glass composition may optionally include at least 0.5 wt. % La₂O₃, including, for example, at least 0.75 wt. %, 0.9 wt. %, 1 wt. %, at least 1.3 wt. %, at least 1.5 wt. %, at least 1.7 wt. %, at least 1.9 wt. %, and at least 2 wt. %. Likewise, the glass composition may include no greater than 3 wt. % La₂O₃, including, for example, no greater than 2.8 wt. %. no greater than 2.5 wt. %, no greater than 2.3 wt. %, no greater than 2 wt. %, no greater than 1.8 wt. %, and no greater than 1.5 wt. %. La₂O₃. In any of the exemplary embodiments, the glass composition may include greater than 1 wt. % to less than 4 wt. % La₂O₃, including from 0.4 wt. % to 2.5 wt. %, from 0.6 wt. % to 2 wt. %, and from 0.8 wt. % to 1.7 wt. %, including all endpoint and ranges therebetween. However, La₂O₃ is optional and may not be included in some embodiments.

In any of the exemplary embodiments, the glass composition may further include one or more additional rare earth oxides. For instance, the glass composition may include CeO₂. When included, the CeO₂ may be present in the glass composition in an amount of from greater than 0 wt. % to 3 wt. %, including from 0.5 wt. % to 2.5 wt. %, from 0.75 wt. % to 2 wt. %, and from 1 wt. % to 1.5 wt. %. In any of the exemplary embodiments, the glass composition includes a total amount of rare earth oxides of from 2 wt. % to 7 wt. %, including from 2.5 wt. % to 6.5 wt. %, and from 3 wt. % to 6.2 wt. %.

The glass composition may further include TiO₂ and/or Fe₂O₃ in individual or collective amounts of at least 0.01 wt. %. For instance, in any of the exemplary embodiments, the glass composition may include from about 0.01 wt. % to about 2 wt. % TiO₂, including from about 0.1 wt. % to about 2 wt. %, from about 0.2 wt. % to about 2 wt. %, from about 0.5 wt. % to about 2 wt. %, from about 0.01 wt. % to about 1.5 wt. %, from about 0.1 wt. % to about 1.5 wt. %, from about 0.2 wt. % to about 1.5 wt. %, from about 0.5 wt. % to about 1.5 wt. %, from about 0.01 wt. % to about 1 wt. %, from about 0.1 wt. % to about 1 wt. %, from about 0.2 wt. % to about 1 wt. %, from about 0.5 wt. % to about 1 wt. %, from about 0.01 wt. % to about 0.8 wt. %, from about 0.1 wt. % to about 0.8 wt. %, from about 0.2 wt. % to about 0.8 wt. %, from about 0.5 wt. % to about 0.8 wt. % TiO₂. Additionally or alternatively, the glass composition may include from greater than 0 wt. % to about 3 wt. % Fe₂O₃, including from about 0.01 wt. % to about 2 wt. %, from about 0.05 wt. % to about 1 wt. % and from about 0.1 wt. % to about 0.5 wt. % Fe₂O₃.

The glass composition may further include ZrO₂ and/or ZnO. For instance, in any of the exemplary embodiments, the glass composition may include from greater than 0 wt. % to about 3 wt. % ZrO₂, including from about 0.1 wt. % to about 2 wt. %, from about 0.5 wt. % to about 1.5 wt. % and from about 1 wt. % to about 1.5 wt. % ZrO₂. Additionally or alternatively, the glass composition may include from greater than 0 wt. % to about 3 wt. % ZnO, including from about 0.01 wt. % to about 2 wt. %, from about 0.05 wt. % to about 1 wt. % and from about 0.1 wt. % to about 0.5 wt. % ZnO. It should be understood that in exemplary embodiments, the glass composition may include ZrO₂, ZnO, ZrO₂ and ZnO, or neither ZrO₂ nor ZnO.

The glass composition includes less than 2 wt. % of the alkali metal oxides Na₂O and K₂O, including between 0 wt. % and 1.5 wt. %, and between an amount greater than 0 wt. % and 1 wt. %. The glass composition may advantageously include both Na₂O and K₂O in an amount greater than 0.01 wt. % of each oxide. In some exemplary embodiments, the glass composition includes from 0 wt. % to about 1 wt. % Na₂O, including from about 0.01 wt. % to about 0.5 wt. %, from about 0.03 wt. % to about 0.3 wt. %, and from 0.04 wt. % to about 0.2 wt. % Na₂O. In these or other embodiments, the glass composition may further include about 0 wt. % to about 1 wt. % K₂O, including from about 0.01 wt. % to about 0.5 wt. %, from about 0.03 wt. % to about 0.3 wt. %, and from about 0.04 wt. % to about 0.2 wt. % K₂O.

Various glass compositions disclosed herein exhibit high performance (and particularly, a high modulus) while being free or substantially free of Li₂O. Accordingly, the glass composition includes less than 2 wt. % of Li₂O, including less than 1.5 wt. %, less than 1 wt. %, less than 0.8 wt. %, less than 0.5 wt. %, less than 0.1 wt. %, less than 0.05 wt. %, and less than 0.01 wt. % Li₂O. In some exemplary embodiments, the glass composition includes between 0 wt. % and less than 1 wt. % Li₂O, including between 0 wt. % and 0.5 wt. %, between 0 wt. % and 0.5 wt. %, and between 0 wt. % and 0.05 wt. %. In some exemplary embodiments, the glass composition is entirely free of Li₂O.

The glass composition may include the alkali metal oxides Li₂O, Na₂O, and K₂O, (collectively, “R₂O”) in individual or collective amounts of at least 0.01 wt. %, while maintaining a total content of R₂O (e.g., sum of the Li₂O content, Na₂O content, and K₂O content) of less than 2 wt. %. In any of the embodiments disclosed herein, the glass composition may have a total content of R₂O of less than 1.5 wt. %, less than 1 wt. %, or less than 0.5 wt. %. In any of the exemplary embodiments, the glass composition may be free of Na₂O and/or K₂O.

The glass composition may also be free or substantially free of B₂O₃ and fluorine, although either, or any, may be added in small amounts to adjust the fiberizing and finished glass properties and will not adversely impact the properties if maintained below several percent. As used herein, substantially free of B₂O₃ and fluorine means that the sum of the amounts of B₂O₃ and fluorine present is less than 1.0 wt. % of the composition. The sum of the amounts of B₂O₃ and fluorine present may be less than about 0.5 wt. % of the composition, including less than about 0.2 wt. %, less than about 0.1 wt. %, and less than about 0.05 wt. %.

The glass compositions may further include impurities and/or trace materials without adversely affecting the glasses or the fibers. These impurities may enter the glass as raw material impurities or may be products formed by the chemical reaction of the molten glass with furnace components. Non-limiting examples of trace materials include zinc, strontium, barium, and combinations thereof. The trace materials may be present in their oxide forms and may further include fluorine and/or chlorine. In some exemplary embodiments, the inventive glass compositions contain less than 1 wt. %, including less than 0.5 wt. %, less than 0.2 wt. %, and less than 0.1 wt. % of each of BaO, SrO, P₂O₅, and SO₃. Particularly, the glass composition may include less than about 5.0 wt. % of BaO, SrO, P₂O₅, and/or SO₃ combined, wherein each of BaO, SrO, P₂O₅, and SO₃ if present at all, is present in an amount of less than 1 wt. %.

The glass composition may be in molten form, obtainable by melting the raw material components of the glass composition in a melter. The glass compositions disclosed herein are suitable for melting in traditional commercially available refractory-lined glass furnaces, which are widely used in the manufacture of glass reinforcement fibers.

Surprisingly, the glass composition demonstrates an acceptably low liquidus temperature, while including a relatively high concentration of MgO (a minimum of 15 wt. %). The liquidus temperature is defined as the highest temperature at which equilibrium exists between liquid glass and its primary crystalline phase. The liquidus temperature, in some instances, may be measured by exposing the glass composition to a temperature gradient in a platinum-alloy boat for 16 hours (ASTM C829-81 (2005)). At all temperatures above the liquidus temperature, the glass is completely molten, i.e., it is free from crystals. At temperatures below the liquidus temperature, crystals may form.

The glass composition has a liquidus temperature below 1,400° C., including liquidus temperature of no greater than 1,375° C., no greater than 1,350° C., no greater than 1,325° C., and no greater than 1,300° C.

The glass composition also exhibits a low fiberizing temperature, which is defined as the temperature that corresponds to a melt viscosity of about 1000 Poise, as determined by ASTM C965-96 (2007) (also known as the log 3 temperature). Lowering the fiberizing temperature may reduce the production cost of the glass fibers because it allows for a longer bushing life and reduced energy usage necessary for melting the components of a glass composition. Therefore, the energy expelled is generally less than the energy necessary to melt many commercially available glass formulations. Such lower energy requirements may also lower the overall manufacturing costs associated with the glass composition.

For example, at a lower fiberizing temperature, a bushing may operate at a cooler temperature and therefore does not “sag” as quickly as is typically seen. “Sag” is a phenomenon that occurs when a bushing that is held at an elevated temperature for extended periods of time loses its determined stability. Thus, by lowering the fiberizing temperature, the sag rate of the bushing may be reduced, and the bushing life can be maximized.

The glass composition has a fiberizing temperature of less 1,315° C., such as, for example, a fiberizing temperature of no greater than 1,300° C., no greater than 1,290° C., no greater than 1,280° C., no greater than 1,275° C., and no greater than 1,270° C.

Although conventional glass compositions were limited to those glass compositions including a positive (>0° C.) temperature differential “ΔT”, which is defined as the difference between the fiberizing temperature and the liquidus temperature, advancing fiberizing technologies enable the use of glass compositions with lower viscosities, and even negative ΔT values. To make a glass fiber, batch ingredients are first eutectically melted and dissolved at a very high temperature in the furnace. This melting temperature is far above both the liquidus temperature and fiberizing temperature. Once melted, the molten glass travels through what is known as a “front end” or forehearth and cools as it travels. Previously, it was important that the ΔT be positive to prevent devitrification or crystals from forming. However, exemplary embodiments described herein include a low or even negative ΔT and remain suitable for fiberizing applications.

In some exemplary embodiments, the glass composition has a ΔT of at less than 15° C., including less than 5° C., less than 1° C., less than −5° C., less than −10° C., less than −15° C., and less than −25° C. In various exemplary embodiments, the glass composition has a ΔT between −105° C. and 15° C., including between −65° C. and 0° C., and between −50° C. and −20° C.

As mentioned above, the glass composition comprises a lithium-free unique blend of oxides that is capable of forming a glass fiber with a high Young's modulus and sufficient forming properties. Particularly, the lithium-free glass composition includes limited amounts of Y₂O₃ and/or La₂O₃ (e.g., less than 6 wt. %) and is capable of forming a glass fiber with a Young's modulus of greater than or equal to 93 GPa.

The Young's modulus (or “elastic modulus”) of a glass fiber may be determined by taking the average measurements on five single glass fibers measured in accordance with the sonic measurement procedure outlined in the report “Glass Fiber and Measuring Facilities at the U.S. Naval Ordnance Laboratory”, Report Number NOLTR 65-87, Jun. 23, 1965. In comparison, another method of measuring modulus is to measure the bulk modulus. Modulus measurements on bulk samples are not representative of the fiber product modulus because of the different thermal histories involved in forming the types of samples. Furthermore, bulk samples must be annealed prior to the cutting, grinding, and polishing required to produce the specific samples needed for the bulk measurement. This annealing step takes the bulk sample atomic structure even further from that of the fiber. Thus, such bulk modulus measurements are not directly comparable to fiber modulus, described herein. Bulk modulus measurements are described in ASTM C1259 or E1876.

The glass fibers formed from the inventive glass composition have a Young's modulus (fiber modulus) of at least about 93 GPa, such as a Young's modulus of at least about 93.25 GPa, at least about 93.5 GPa, at least about 93.75 GPa, at least about 94 GPa, at least about 94.25 GPa, at least about 94.5 GPa, at least about 94.75 GPa, at least about 95 GPa, and at least about 95.25 GPa. In some exemplary embodiments, the exemplary glass fibers formed from the inventive glass composition have a Young's modulus of between about 93 GPa and about 96 GPa, including between about 93.5 GPa and about 95.5 GPa, and between about 94 GPa and about 95.5 GPa.

Table 1, below, provides various exemplary compositional ranges formulated in accordance with the present inventive concepts.

TABLE 1

| | Exemplary Ranges A | Exemplary Ranges B |
|---|---|---|
| SiO₂ | 50-60 | 55-59 |
| Al₂O₃ | 15-20 | 16-19 |
| CaO | 0.5-5 | 1-3 |
| MgO | 15-20 | 16-19 |
| SiO₂/(MgO + CaO) | 2.5-3.3 | 2.7-3 |
| Y₂O₃ | 1-5.5 | 2-4 |
| La₂O₃ | 0-4 | 1-2 |
| Y₂O₃ + La₂O₃ | 2-6 | 3-5 |
| Na₂O + K₂O | 0-1 | 0.01-0.5 |
| Li₂O | 0-0.5 | 0-0.05 |
| Fe₂O₃ | 0-3 | 0.01-0.1 |
| TiO₂ | 0-2 | 0.2-1 |

As indicated above, the inventive glass compositions unexpectedly demonstrate an optimized elastic modulus, while maintaining desirable forming properties, including fiberizing temperatures below 1,315° C. and without requiring relatively large amounts of LiO₂ and rare earth oxides such as Y₂O₃ and La₂O₃.

In any of the exemplary embodiments, the glass composition disclosed herein forms glass fibers having a density between 2.2 g/cc to 3.0 g/cc. The density may be measured by any method known and commonly accepted in the art, such as the Archimedes method (ASTM C693-93 (2008)) on unannealed bulk glass. In any of the exemplary embodiments, the glass fibers may have a density between 2.3 g/cc to 2.85 g/cc, including from 2.5 g/cc to 2.8 g/cc, 2.55 to 2.75 g/cc, and 2.6 to 2.7 g/cc.

According to some exemplary embodiments, a method is provided for preparing glass fibers from the glass composition described above. The glass fibers may be formed by any means known and traditionally used in the art. In some exemplary embodiments, the glass fibers are formed by obtaining raw ingredients and mixing the ingredients in the appropriate quantities to give the desired weight percentages of the final composition. The method may further include providing the inventive glass composition in molten form and drawing the molten composition through orifices in a bushing to form a glass fiber.

The components of the glass composition may be obtained from suitable ingredients or raw materials including, but not limited to, sand or pyrophyllite for SiO₂, limestone, burnt lime, wollastonite, or dolomite for CaO, kaolin, alumina or pyrophyllite for Al₂O₃, dolomite, dolomitic quicklime, brucite, enstatite, talc, burnt magnesite, or magnesite for MgO, and sodium carbonate, sodium feldspar or sodium sulfate for the Na₂O. In some exemplary embodiments, glass cullet may be used to supply one or more of the needed oxides. As mentioned above, the subject glass composition includes a reduced amount of limestone, dolomite, and magnesite.

The mixed batch may then be melted in a furnace or melter and the resulting molten glass is passed along a forehearth and drawn through the orifices of a bushing located at the bottom of the forehearth to form individual glass filaments. In some exemplary embodiments, the furnace or melter is a traditional refractory melter. By utilizing a refractory tank formed of refractory blocks, manufacturing costs associated with the production of glass fibers produced by the inventive composition may be reduced. In some exemplary embodiments, the bushing is a platinum alloy-based bushing. Strands of glass fibers may then be formed by gathering the individual filaments together. The fiber strands may be wound and further processed in a conventional manner suitable for the intended application.

The operating temperatures of the glass in the melter, forehearth, and bushing may be selected to appropriately adjust the viscosity of the glass, and may be maintained using suitable methods, such as control devices. The temperature at the front end of the melter may be automatically controlled to reduce or eliminate devitrification. The molten glass may then be pulled (drawn) through holes or orifices in the bottom or tip plate of the bushing to form glass fibers. In accordance with some exemplary embodiments, the streams of molten glass flowing through the bushing orifices are attenuated to filaments by winding a strand formed of a plurality of individual filaments on a forming tube mounted on a rotatable collet of a winding machine or chopped at an adaptive speed. The glass fibers of the invention are obtainable by any of the methods described herein, or any known method for forming glass fibers.

The fibers may be further processed in a conventional manner suitable for the intended application. For instance, in some exemplary embodiments, the glass fibers are sized with a sizing composition known to those of skill in the art. The sizing composition is in no way restricted, and may be any sizing composition suitable for application to glass fibers. The sized fibers may be used for reinforcing substrates such as a variety of plastics where the product's end use requires high strength and stiffness and low weight. Such applications include, but are not limited to, nonwoven mats and woven fabrics for use in forming wind turbine blades; infrastructure, such as reinforcing concrete, bridges, etc.; and aerospace structures. Exemplary woven fabrics include, for example, unidirectional, uniaxial, multiaxial, stitched fabric, and the like.

In this regard, some exemplary embodiments of the present invention include a composite material incorporating the inventive glass fibers, as described above, in combination with a hardenable matrix material. This may also be referred to herein as a reinforced composite product. The matrix material may be any suitable thermoplastic or thermoset resin known to those of skill in the art, such as, but not limited to, thermoplastics such as polyesters, polypropylene, polyamide, polyethylene terephthalate, and polybutylene, and thermoset resins such as epoxy resins, unsaturated polyesters, phenolics, vinylesters, and elastomers. These resins may be used alone or in combination. The reinforced composite product may be used for wind turbine blade, rebar, pipe, filament winding, muffler filling, sound absorption, and the like.

In accordance with further exemplary embodiments, the invention provides a method of preparing a composite product as described above. The method may include combining at least one polymer matrix material with a plurality of glass fibers. Both the polymer matrix material and the glass fibers may be as described above.

### Examples

Exemplary glass compositions according to the present invention were prepared by mixing batch components in proportioned amounts to achieve a final glass composition with the oxide weight percentages set forth in Tables 2, 3, and 4 below.

The raw materials were melted in a platinum crucible in an electrically heated furnace at a temperature of 1,600° C. for 3 hours. The fiberizing temperature was measured using a rotating cylinder method as described in ASTM C965-96 (2007), entitled “Standard Practice for Measuring Viscosity of Glass Above the Softening Point,” the contents of which are incorporated by reference herein. The liquidus temperature was measured by exposing glass to a temperature gradient in a platinum-alloy boat for 16 hours, as defined in ASTM C829-81 (2005), entitled “Standard Practices for Measurement of Liquidus Temperature of Glass,” the contents of which are incorporated by reference herein. Density was measured by the Archimedes method, as detailed in ASTM C693-93 (2008), entitled “Standard Test Method for Density of Glass Buoyancy,” the contents of which are incorporated by reference herein.

The elastic modulus was measured by the sonic fiber technique, in accordance with the measurement procedure outlined in the report “Glass Fiber Drawing and Measuring Facilities at the U.S. Naval Ordnance Laboratory.” Report Number NOLTR 65-87. Jun. 23, 1965. The specific modulus was calculated by dividing the measured clastic modulus in units of GPa by the density in units of kg/m³.

TABLE 2

| | COMP. | COMP. | COMP. | COMP. | COMP. | | | | |
|---|---|---|---|---|---|---|---|---|---|
| | EX. 1 | EX. 2 | EX. 3 | EX. 4 | EX. 5 | EX. 1 | EX. 2 | EX. 3 | EX. 4 |
| | (wt. %) | (wt. %) | (wt. %) | (wt. %) | (wt. %) | (wt. %) | (wt. %) | (wt. %) | (wt. %) |
| SiO₂ | 54.0 | 54.0 | 54.0 | 54.4 | 54.4 | 56.9 | 55.3 | 57.8 | 57.8 |
| Al₂O₃ | 20.2 | 20.2 | 20.2 | 20.2 | 20.2 | 17.7 | 18.5 | 16.0 | 18.5 |
| CaO | 4.5 | 4.5 | 4.5 | 4.5 | 4.5 | 1.4 | 1.4 | 1.4 | 1.4 |
| MgO | 11.1 | 11.1 | 11.1 | 11.0 | 11.1 | 17.7 | 18.5 | 18.5 | 16.0 |
| CaO + MgO | 15.6 | 15.6 | 15.6 | 15.5 | 15.6 | 19.1 | 19.9 | 19.9 | 17.4 |
| MgO/CaO | 2.5 | 2.5 | 2.5 | 2.5 | 2.5 | 12.6 | 13.2 | 13.2 | 11.4 |
| Al₂O₃/MgO | 1.8 | 1.8 | 1.8 | 1.8 | 1.8 | 1.0 | 1.0 | 0.9 | 1.2 |
| SiO₂/ | 3.5 | 3.5 | 3.5 | 3.5 | 3.5 | 3.0 | 2.8 | 2.9 | 3.3 |
| (MgO + CaO) | | | | | | | | | |
| Y₂O₃ | 6.0 | 6.0 | 6.6 | 6.0 | 8.0 | 2.8 | 2.8 | 2.8 | 2.8 |
| La₂O₃ | 2.0 | 2.0 | 2.0 | 2.0 | 0.0 | 1.4 | 1.4 | 1.4 | 1.4 |
| Na₂O | 0.2 | 0.2 | 0.3 | 0.3 | 0.3 | 0.0 | 0.0 | 0.0 | 0.0 |
| K₂O | 0.0 | 0.0 | 0.0 | 0.0 | 0.0 | 0.1 | 0.1 | 0.1 | 0.1 |
| Li₂O | 1.0 | 0.5 | 0.0 | 0.0 | 0.2 | 0.0 | 0.0 | 0.0 | 0.0 |
| Fe₂O₃ | 0.2 | 0.2 | 0.1 | 0.1 | 0.1 | 0.0 | 0.0 | 0.0 | 0.0 |
| TiO₂ | 0.4 | 0.4 | 0.1 | 0.1 | 0.1 | 0.5 | 0.5 | 0.5 | 0.5 |
| ZrO₂ | 0.5 | 1.0 | 1.2 | 1.5 | 1.2 | 1.5 | 1.5 | 1.5 | 1.5 |
| Y₂O₃ + La₂O₃ | 8.0 | 8.0 | 8.6 | 8.0 | 8.0 | 4.2 | 4.2 | 4.2 | 4.2 |
| Y₂O₃/La₂O₃ | 3.0 | 3.0 | 3.3 | 3.0 | — | 2.0 | 2.0 | 2.0 | 2.0 |
| Fiberizing | 1252 | 1269 | 1290 | 1294 | 1287 | 1266 | 1242 | 1265 | 1296 |
| Temperature (° C.) | | | | | | | | | |
| Liquidus | 1227 | 1242 | 1281 | 1291 | 1274 | 1302 | 1299 | 1369 | 1285 |
| Temperature (° C.) | | | | | | | | | |
| ΔT (° C.) | 25 | 7 | 9 | 3 | 14 | −36 | −57 | −105 | 12 |
| Density (g/cm³) | 2.74 | 2.75 | 2.76 | 2.75 | 2.74 | 2.71 | 2.72 | 2.71 | 2.68 |
| Sonic Fiber | 95.0 | 94.8 | 93.7 | 93.2 | 94.6 | 95.2 | 95.8 | 95.1 | 93.7 |
| Modulus (GPa) | | | | | | | | | |

TABLE 3

| | COMP. | COMP. | COMP. | COMP. | | | | | |
|---|---|---|---|---|---|---|---|---|---|
| | EX. 6 | EX. 7 | EX. 8 | EX. 9 | EX. 5 | EX. 6 | EX. 7 | EX. 8 | EX. 9 |
| | (wt. %) | (wt. %) | (wt. %) | (wt. %) | (wt. %) | (wt. %) | (wt. %) | (wt. %) | (wt. %) |
| SiO₂ | 54.8 | 54.0 | 53.8 | 54.3 | 58.2 | 57.7 | 57.2 | 56.7 | 56.9 |
| Al₂O₃ | 20.3 | 20.0 | 20.2 | 20.2 | 17.7 | 17.7 | 17.7 | 17.7 | 17.7 |
| CaO | 4.8 | 4.5 | 4.5 | 4.5 | 1.4 | 1.4 | 1.4 | 1.4 | 1.4 |
| MgO | 11.3 | 11.0 | 11.1 | 11.1 | 17.7 | 17.7 | 17.7 | 17.7 | 19.0 |
| CaO + MgO | 16.1 | 15.5 | 15.6 | 15.6 | 19.1 | 19.1 | 19.1 | 19.1 | 20.4 |
| MgO/CaO | 2.4 | 2.4 | 2.5 | 2.5 | 12.6 | 12.6 | 12.6 | 12.6 | 13.6 |
| Al₂O₃/MgO | 1.8 | 1.8 | 1.8 | 1.8 | 1.0 | 1.0 | 1.0 | 1.0 | 0.9 |
| SiO₂/ | 3.4 | 3.5 | 3.4 | 3.5 | 3.0 | 3.0 | 3.0 | 3.0 | 2.8 |
| (MgO + CaO) | | | | | | | | | |
| Y₂O₃ | 6.5 | 6.0 | 6.5 | 6.7 | 2.8 | 2.8 | 2.8 | 2.8 | 2.8 |
| La₂O₃ | 0.0 | 2.0 | 2.5 | 2.0 | 1.4 | 1.4 | 1.4 | 1.4 | 1.4 |
| Ce₂O₃ | 0.0 | 0.0 | 0.0 | 0.0 | 0.5 | 1.0 | 1.5 | 2.0 | 0.5 |
| Na₂O | 0.3 | 0.0 | 0.1 | 0.1 | 0.0 | 0.0 | 0.0 | 0.0 | 0.0 |
| K₂O | 0.0 | 0.0 | 0.2 | 0.2 | 0.1 | 0.1 | 0.1 | 0.1 | 0.1 |
| Li₂O | 0.25 | 0.0 | 1.0 | 0.8 | 0.0 | 0.0 | 0.0 | 0.0 | 0.0 |
| Fe₂O₃ | 0.1 | 0.0 | 0.1 | 0.1 | 0.0 | 0.0 | 0.0 | 0.0 | 0.0 |
| TiO₂ | 0.5 | 0.0 | 0.1 | 0.1 | 0.2 | 0.2 | 0.2 | 0.2 | 0.2 |
| ZrO₂ | 1.2 | 0.5 | 0.0 | 0.0 | 0.0 | 0.0 | 0.0 | 0.0 | 0.0 |
| ZnO | 0.0 | 2.0 | 0.0 | 0.0 | 0.0 | 0.0 | 0.0 | 0.0 | 0.0 |
| Y₂O₃ + La₂O₃ | 6.5 | 8.0 | 9.0 | 8.7 | 4.2 | 4.2 | 4.2 | 4.2 | 4.2 |
| Y₂O₃/La₂O₃ | — | 3.0 | 2.6 | 3.4 | 2.0 | 2.0 | 2.0 | 2.0 | 2.0 |
| Fiberizing | 1282 | 1285 | 1254 | 1264 | 1272 | 1282 | 1269 | 1259 | 1248 |
| Temperature (° C.) | | | | | | | | | |
| Liquidus | 1280 | 1276 | 1231 | 1246 | 1313 | 1302 | 1297 | 1286 | 1312 |
| Temperature (° C.) | | | | | | | | | |
| ΔT (° C.) | 2 | 9 | 23 | 18 | −41 | −20 | −28 | −27 | −64 |
| Density (g/cm³) | 2.72 | 2.77 | 2.75 | 2.74 | 2.68 | 2.69 | 2.70 | 2.71 | 2.70 |
| Sonic Fiber | 94.1 | 93.7 | 94.7 | 94.3 | 93.8 | 94.0 | 93.9 | 93.8 | 94.8 |
| Modulus (GPa) | | | | | | | | | |

TABLE 4

| | COMP. | COMP. | | | | | | | |
|---|---|---|---|---|---|---|---|---|---|
| | EX. 10 | EX. 11 | EX. 10 | EX. 11 | EX. 12 | EX. 13 | EX. 14 | EX. 15 | EX. 16 |
| | (wt. %) | (wt. %) | (wt. %) | (wt. %) | (wt. %) | (wt. %) | (wt. %) | (wt. %) | (wt. %) |
| SiO₂ | 54.0 | 54.1 | 58.2 | 58.2 | 58.2 | 56.7 | 58.1 | 56.7 | 56.5 |
| Al₂O₃ | 20.2 | 20.5 | 17.7 | 17.7 | 17.7 | 17.7 | 17.7 | 17.7 | 17.7 |
| CaO | 4.5 | 5.0 | 1.4 | 1.4 | 1.4 | 1.4 | 1.4 | 1.4 | 1.4 |
| MgO | 11.1 | 11.1 | 17.2 | 16.7 | 16.2 | 17.7 | 17.7 | 17.7 | 17.7 |
| CaO + MgO | 15.6 | 16.1 | 18.6 | 18.6 | 17.6 | 19.1 | 19.1 | 19.1 | 19.1 |
| MgO/CaO | 2.5 | 2.2 | 12.3 | 11.9 | 11.6 | 12.6 | 12.6 | 12.6 | 12.6 |
| Al₂O₃/MgO | 1.8 | 1.8 | 1.0 | 1.1 | 1.1 | 1.0 | 1.0 | 1.0 | 1.0 |
| SiO₂/ | 3.5 | 3.4 | 3.1 | 3.2 | 3.3 | 3.0 | 3.0 | 3.0 | 3.0 |
| (MgO + CaO) | | | | | | | | | |
| Y₂O₃ | 6.5 | 6.0 | 2.8 | 2.8 | 2.8 | 2.8 | 2.8 | 2.8 | 2.8 |
| La₂O₃ | 2.5 | 2.0 | 1.4 | 1.4 | 1.4 | 1.4 | 1.4 | 1.4 | 1.4 |
| Ce₂O₃ | 0.0 | 0.0 | 1.0 | 1.5 | 2.0 | 1.0 | 0.0 | 0.8 | 0.0 |
| Na₂O | 0.1 | 0.1 | 0.0 | 0.0 | 0.0 | 0.0 | 0.0 | 0.0 | 0.2 |
| K₂O | 0.2 | 0.1 | 0.1 | 0.1 | 0.1 | 0.1 | 0.1 | 0.1 | 0.1 |
| Li₂O | 0.8 | 1.0 | 0.0 | 0.0 | 0.0 | 0.0 | 0.0 | 0.0 | 0.0 |
| Fe₂O₃ | 0.1 | 0.1 | 0.0 | 0.0 | 0.0 | 0.0 | 0.0 | 0.0 | 0.1 |
| TiO₂ | 0.1 | 0.1 | 0.2 | 0.2 | 0.2 | 0.2 | 0.8 | 0.5 | 0.6 |
| ZrO₂ | 0.0 | 0.0 | 0.0 | 0.0 | 0.0 | 1.0 | 0.0 | 1.0 | 1.5 |
| Y₂O₃ + La₂O₃ | 9.0 | 8.0 | 4.2 | 4.2 | 4.2 | 4.2 | 4.2 | 4.2 | 4.2 |
| Y₂O₃/La₂O₃ | 2.6 | 3.0 | 2.0 | 2.0 | 2.0 | 2.0 | 2.0 | 2.0 | 2.0 |
| Fiberizing | 1262 | 1255 | 1270 | 1282 | 1285 | 1248 | 1272 | 1266 | 1262 |
| Temperature (° C.) | | | | | | | | | |
| Liquidus | 1245 | 1235 | 1297 | 1305 | 1298 | 1290 | 1299 | 1288 | 1294 |
| Temperature (° C) | | | | | | | | | |
| ΔT (° C.) | 17 | 20 | −27 | −23 | −13 | −42 | −27 | −23 | −31 |
| Density (g/cm³) | 2.75 | 2.73 | 2.68 | 2.69 | 2.69 | 2.72 | 2.68 | 2.72 | 2.71 |
| Sonic Fiber | 94.5 | 94.7 | 93.4 | 93.1 | 93.0 | 95.0 | 93.7 | 95.2 | 95.1 |
| Modulus (GPa) | | | | | | | | | |

Tables 2. 3 and 4 illustrate the challenges the subject glass composition overcame to achieve a glass with a fiberizing temperature below 1,315° C. and a sonic fiber elastic modulus that is at least 93 GPa, while including less than 0.5 wt. % of Li₂O, having Y₂O₃ and La₂O₃ present in a total amount of less than or equal to 6 wt. %, and having a MgO content of greater than or equal to 15 wt. %. The Comparative prior art glass compositions are unable to achieve each of these parameters in a single glass composition and thus an important technical effect has been identified within the particular glass composition described herein.

Particularly, as illustrated in Table 2, Comparative Examples 1 and 8-11 each include greater than 0.5 wt. % lithium to achieve an elastic modulus of at least 93 GPa. Comparative Examples 1-9 also include a relatively low amount of MgO (e.g., less than 15 wt. %) and a high total amount of Y₂O₃ and/or La₂O₃ (e.g., above 6 wt. %). However, each of Examples 1-16 demonstrate that balancing the amount of MgO and CaO to achieve a ratio of greater than or equal to 11.0 and an amount of MgO of greater than 15 wt. % enables the lithium to be removed and the total amount of Y₂O₃ and La₂O₃ to be reduced, while maintaining an elastic modulus of at least 93 GPa and having fiberizing temperatures below 1,315° C.

Various aspects of the present disclosure have been described above both generically and with regard to specific embodiments. Although the invention has been set forth in what is believed to be the preferred embodiments, a wide variety of alternatives known to those of skill in the art can be selected within the generic disclosure. The invention is not otherwise limited, except for the recitation of the claims set forth below.

1. A glass composition comprising:
SiO₂ in an amount of from 50 wt. % to 60 wt. %;
Al₂O₃ in an amount of less than 20 wt. %;
CaO in an amount of less than 5 wt. %;
MgO in an amount of greater than or equal to 15 wt. %;
Y₂O₃ and, optionally, La₂O₃ present in a sum concentration of from 2 wt. % to 6 wt. %; and
less than 0.5 wt. % of Li₂O,
wherein the glass composition has a Young's modulus of greater than or equal to 93 GPa.

2. The glass composition of claim 1, wherein the glass composition has a Young's modulus or greater than or equal to 95 GPa.

3. The glass composition of claim 1, wherein the glass composition further comprises ZrO₂ in an amount of from 0.1 wt. % to 2 wt. %.

4. The glass composition of claim 1, wherein the glass composition further comprises TiO₂ in an amount of from 0.1 wt. % to 2 wt. %.

5. The glass composition of claim 1, wherein the glass composition comprises a total content of R₂O (R₂O═Li₂O+Na₂O+K₂O) of less than 2 wt. %.

6. The glass composition of claim 1, wherein the glass composition further comprises Fe₂O₃ in an amount of from 0 wt. % to 3 wt. %.

7. The glass composition of claim 1, wherein the glass composition further comprises ZnO in an amount of from 0 wt. % to 3 wt. %.

8. The glass composition of claim 1, wherein the glass composition further comprises CeO₂.

9. The glass composition of claim 1, wherein the amount of Y₂O₃ is greater than the amount of La₂O₃.

10. The glass composition of claim 1, wherein the composition is free of La₂O₃.

11. The glass composition of claim 1, wherein the glass composition comprises amounts of SiO₂, MgO, and CaO that satisfy the relationship SiO₂/(MgO+CaO)≤3.3.

12. The glass composition of claim 1, wherein the glass composition comprises amounts of MgO and CaO that satisfy the relationship MgO/CaO≥11.0.

13. The glass composition of claim 1, wherein the glass composition comprises amounts of Al₂O₃ and MgO that satisfy the relationship Al₂O₃/MgO≤1.5.

14. The glass composition of claim 1, wherein the glass composition has a fiberizing temperature that is less than 1315° C.

15. A lithium-free glass composition comprising:
SiO₂ in an amount of from 50 wt. % to 60 wt. %;
Al₂O₃ in an amount of from 15 wt. % to 20 wt. %;
CaO in an amount of from 1 wt. % to 5 wt. %;
MgO in an amount of greater than or equal to 15 wt. %; and
Y₂O₃ and, optionally, La₂O₃ present in a sum concentration of from 2 wt. % to 6 wt. %,
wherein the glass composition has a Young's modulus of greater than or equal to 95 GPa, and wherein the glass composition satisfies at least one of the following:
the glass composition comprises amounts of SiO₂, MgO, and CaO that satisfy the relationship SiO₂/(MgO+CaO)<3.0;
the glass composition comprises amounts of MgO and CaO that satisfy the relationship MgO/CaO≥12.5; and
the glass composition comprises amounts of Al₂O₃ and MgO that satisfy the relationship Al₂O₃/MgO≤1.0.

16. The glass composition of claim 15, wherein the glass composition has a fiberizing temperature that is less than 1315° C.

17. The glass composition of claim 15, wherein the composition is free of La₂O₃.

18. A method of forming a continuous glass fiber comprising:
providing a molten glass composition according to claim 1; and
drawing said molten composition through an orifice to form a continuous glass fiber.

19. A reinforced composite product comprising:
a polymer matrix; and
a plurality of glass fibers formed from the glass composition of claim 1.

20. A reinforced composite product according to claim 19, wherein the reinforced composite product is in the form of a wind blade.
